(19) United States
(12) Patent Application Publication
(10) Pub. No.: US 2020/0301092 A1
(43) Pub. Date: Sep. 24, 2020

(54) LENS UNIT AND METHOD FOR MANUFACTURING LENS UNIT

(71) Applicant: NIDEC SANKYO CORPORATION, Nagano (JP)

(72) Inventors: Toshio SHIROTORI, Nagano (JP); Yosuke KANZAKI, Nagano (JP); Tadashi KOMIYAMA, Nagano (JP)

(21) Appl. No.: 16/825,310

(22) Filed: Mar. 20, 2020

(30) Foreign Application Priority Data
Mar. 20, 2019 (JP) 2019052252

(51) Int. Cl. G02B 7/02; H04N 5/225

(52) U.S. Cl. CPC G02B 7/021; H04N 5/2254; G02B 7/022

(57) ABSTRACT

A protrusion part which protrudes locally from the periphery of a fifth lens body toward an image side may be provided on an image side of the fifth lens body. On an object side of a cemented lens, a cemented lens upper surface abutting against the protrusion part on the outside of a lens surface may be provided. The protrusion part may be formed in number at equal intervals in the circumferential direction, and the protrusion parts may be divided into seven protrusion part groups each including three protrusion parts in accordance with the protrusion amount to the image side. The protrusion part which actually abuts against the cemented lens upper surface may be selected from among the protrusion parts in accordance with the thickness of a fifth lens as actually measured, so that the interval between the fifth lens and the cemented lens may be of an appropriate value.

### CROSS REFERENCE TO RELATED APPLICATION

The present application claims priority under 35 U.S.C. § 119 to Japanese Application No. 2019-052252 filed on Mar. 20, 2019, the entire content of which is incorporated herein by reference.

### BACKGROUND

### Field of the Invention

At least an embodiment of the present invention relates to a lens unit that includes a plurality of lenses and a lens barrel accommodating and fixing the plurality of lenses, and a method for manufacturing a lens unit.

### Description of the Background Art

A lens unit in which a plurality of lenses are arranged from an object side to an image side (image pickup element side) in an optical axis (optical axis of the image pickup apparatus) direction has been used as an optical system used in an image pickup apparatus mounted on, for example, an automobile, a monitoring camera and the like. This lens unit is designed so as to make the imaging of an image of an object by visible light on an image pickup element good. Therefore, it is necessary that the positional relationship among each lens, the positional relationship between each lens and a lens barrel, and the positional relationship between the lens unit and the image pickup element is fixed with a high accuracy.

In this case, the lens barrel is constituted by a resin material having a high weatherability. Further, there are two types of materials that serve as the material for constructing the lens in this kind of small image pickup apparatus: glass and resin material. In case of glass, the mechanical strength is high, but glass is expensive, and in the latter case of a resin material, the mechanical strength is low, but the resin material is inexpensive. The coefficient of thermal expansion of glass is generally lower than a resin material, thus, the lens in which the influence on the imaging characteristics (change in focal point and the like) becomes large due to minute changes in the shape and position caused by thermal expansion at high temperatures is preferably made of glass (glass lens). On the one hand, lenses made of a resin material (plastic lens) are inexpensive, and furthermore, aspherically-shaped lenses are relatively inexpensive to manufacture. Weatherability is specifically necessary for the resin material for a lens barrel, whereas optical characteristics (light transmittance and the like) are necessary for the resin material for a lens, thus, different resin materials are used for the lens barrel and the lens, and crystalline plastic can be used for the lens barrel, while amorphous plastic can be used for lenses.

Even when forming lens surfaces of the same shape, different techniques can be used for plastic lenses and glass lenses, and in the case of plastic lenses, resin molding can be used, whereas in the case of glass lenses, a polishing process can be used. On the one hand, with regards to the thickness of the lens, an accuracy of several μm or less is achieved in the case of a plastic lens manufactured by resin molding, whereas in the case of a glass lens, the accuracy is roughly several tens of μm which is coarser than that of the plastic lens. Therefore, in order to precisely set an interval between the glass lens and the lens adjacent to the glass lens in the optical axis direction, it is necessary to consider the variation of the thickness of this kind of glass lens.

Therefore, Japanese Unexamined Patent Application Publication No. 2018-54922 describes the technique which makes it possible to finely adjust the interval between the glass lens and the lens adjacent to the glass lens in a lens unit in which a glass lens is used in a part. Herein, the glass lens is fixed to a lens holder made of a resin material, a plurality of protrusion parts protruding to the adjacent lens side are provided in the lens holder, and the interval between this lens and the lens holder (glass lens) is determined by the protrusion amount of the protrusion parts. This protrusion part is constructed of a resin material. thus, the protrusion amount may be adjusted by heating and melting processing in accordance with the measured thickness of the glass lens. The aforementioned lens interval can be finely adjusted thereby, and the lens unit having good imaging characteristics can be obtained regardless of the thickness of the glass lens.

In the technique described in Japanese Unexamined Patent Application Publication No. 2018-54922, the accuracy of the lens interval is determined by the accuracy of the protrusion amount, which is determined by the heating and melting processing, thus, the accuracy is not high, or expensive equipment is necessary in order to perform this processing at a high accuracy. Therefore, it is difficult to obtain an inexpensive lens unit in which the interval between the lenses with could be adjusted with a high accuracy.

It is an object of the present invention, in consideration of the above circumstances, to provide an inexpensive lens unit in which the intervals between the lenses are adjusted with a high accuracy and a method for manufacturing the lens unit.

### SUMMARY

A lens unit according to at least an embodiment of the present invention may include a first lens arranged furthest on an object side along an optical axis, a plurality of lenses arranged on an image side relative to the first lens, and a lens barrel accommodating the first lens and the plurality of lenses. The plurality of lenses may include a glass lens that is made of glass, supported by a lens holder outside as viewed from the optical axis, and accommodated in the lens barrel. The lens holder may be provided, on one side in an optical axis direction, with a plurality of protrusion parts locally protruding toward the one side, and the plurality of protrusion parts are divided into a plurality of protrusion part groups in accordance with a protrusion amount. The plurality of lenses may also include a one side lens that is adjacent to the glass lens on the one side in the optical axis direction and is locked by protrusion parts belonging to one of the plurality of protrusion part groups to allow a positional relationship between the one side lens and the glass lens to be determined in the optical axis direction.

In this configuration, a lens body in which the glass lens may be integrated with the lens holder is accommodated in the lens barrel. The lens body (lens holder) and the one side lens may abut against the plurality of protrusion parts formed in the lens holder, and the interval in the optical axis direction between the glass lens and the one side lens may be determined by the protrusion amount of the protrusion parts. Since the protrusion amount of the protrusion parts can be precisely determined for each protrusion part group during the formation of the lens holder, the interval can be finely adjusted by selecting a protrusion part group. As a result, the imaging characteristics of the lens unit can be improved even when there is variation in the thickness, etc., of the glass lens.

The plurality of lenses may include an other side lens that is adjacent to the glass lens on another side of the lens holder. An engagement structure formed in the other side lens and an engagement structure formed in the lens holder may engage with each other to allow a positional relationship between the other side lens and the lens holder to be fixed in at least the optical axis direction or a direction perpendicular to the optical axis. The plurality of protrusion parts and the engagement structures formed in the other side lens and in the lens holder may have overlapping regions when viewed in the optical axis direction.

In this configuration, the positional relationship between the other side lens adjacent to the glass lens on the other side of the glass lens and the lens holder may be determined by the engagement structures. The positional relationship between the one side lens, the glass lens (lens body) and the other side lens may be determined thereby. In this case, causing the engagement structures and the protrusion parts to overlap each other when viewed from the optical axis direction suppresses distortion produced in the lens barrel or the plastic lenses (one side lens and other side lens) when installing the other side lens after the lens body or installing the lens body and the one side lens after the other side lens in the lens barrel.

Further, the plurality of lenses may include two lenses that are adjacent to each other in the optical axis direction and are joined together to form a cemented lens serving as the one side lens.

In this configuration, the one side lens may be the cemented lens. Such a configuration increases the degrees of freedom of the configuration of a lens system.

Further, a thin-film infrared cut filter that blocks light of a longer wavelength than light as a target for imaging may be formed on a surface on the image side of the glass lens.

By using the thin-film infrared cut filter, specifically, near-infrared light that is not necessary as a target for imaging and does not yield good imaging characteristics is prevented from reaching the image surface, and it becomes unnecessary to provide the infrared cut filter as a separate component. While the interval between the glass lens on which the infrared cut filter has been formed and the one side lens may influence the occurrence of ghosting and flaring, such adverse effects can be suppressed by finely adjusting the interval using the aforementioned protrusion parts.

A lens unit manufacturing method according to at least an embodiment of the present invention may be a method for manufacturing the lens unit as above and may include arranging the glass lens in a lens installation hole made by digging a region around the optical axis of the lens holder down in the optical axis direction, fixing the glass lens to an inner surface of the lens installation hole with an adhesive agent, measuring a thickness along the optical axis direction of the glass lens after fixing, selecting a protrusion part group from among the plurality of protrusion part groups in accordance with the thickness, processing protrusion parts that belong to another protrusion part group and have a larger protrusion amount than protrusion parts belonging to the protrusion part group as selected, to allow the protrusion parts belonging to the protrusion part group as selected to lock the one side lens, and arranging a lens body that includes the glass lens fixed to the lens holder in the lens barrel after the processing of protrusion parts.

In this lens unit manufacturing method, the lens body may be produced by the arranging and the fixing of the glass lens. Then, protrusion parts (protrusion part group) abutting to the one side lens may be determined by the selecting of a protrusion part group and the processing of protrusion parts to make the interval between the one side lens and the glass lens appropriate before the lens body is arranged in the lens barrel. In the processing of protrusion parts, processing may be performed on the protrusion parts having a larger protrusion amount than the selected protrusion part group, which does not need a high accuracy. Therefore, the fine adjustment of the lens interval is possible, and the manufacturing of the lens unit is easy.

A projection part, which protrudes to a side opposite to a side where the lens installation hole is dug down along the optical axis direction, may be formed in a periphery of the lens installation hole in the lens holder as viewed from the optical axis. In that case, the lens unit manufacturing method includes, between the arranging and the fixing of the glass lens, swaging to bend the projection part toward the optical axis while keeping the projection part in a non-contact state with the glass lens.

By providing the projection part in the lens holder in this way, the placement of the glass lens within the lens installation hole is easy, and the glass lens is fixed to the lens holder after the fixing, even in the location where there is a projection part. Further, the glass lens is prevented from moving from the lens holder prior to solidification of the adhesive agent.

The lens unit manufacturing method may include, between the fixing of the glass lens and the arranging of the lens body, installing an aperture on a surface on another side of the lens holder.

In that case, not only the glass lens but also the aperture is fixed to the lens holder. Therefore, the positional relationship between the glass lens, the one side lens, the other side lens, and the aperture is fixed through the lens holder.

According to at least an embodiment of the present invention, an inexpensive lens unit in which the intervals between lenses are adjusted with a high accuracy and a method for manufacturing the lens unit are obtained.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view of a lens unit according to an embodiment of the present invention;

FIG. 2A is a cross-sectional view of a lens barrel used in the lens unit according to the embodiment;

FIG. 2B is a perspective view of the lens barrel used in the lens unit according to the embodiment;

FIG. 3 is an exploded view of the lens unit according to the embodiment;

FIG. 4 is a perspective view of a lens holder in the lens unit according to the embodiment as viewed from an image side;

FIG. 5 is a plan view of the lens holder in the lens unit according to the embodiment as viewed from an object side, illustrating the lens holder in which a fifth lens has been arranged;

FIG. 6A is a plan view of the lens holder alone in the lens unit according to the embodiment as viewed from the image side;

FIG. 6B is a plan view of the lens holder in the lens unit according to the embodiment as viewed from the image side, illustrating the lens holder in which the fifth lens has been arranged;

FIG. 7 is a cross-sectional view along the optical axis of a fifth lens body in the lens unit according to the embodiment;

FIG. 8 is a perspective view illustrating the relationship between the fifth lens body and an aperture in the lens unit according to the embodiment;

FIGS. 9A through 9C are cross-sectional views describing a process for manufacturing the fifth lens body in the lens unit according to the embodiment; and

FIG. 10 is a cross-sectional view illustrating the positional relationship between a protrusion part in the lens unit and a stepped part and the like on an upper side relative to the protrusion part in the lens unit according to the embodiment.

### DESCRIPTION OF THE PREFERRED EMBODIMENTS

The embodiments of the present invention will be described below using the drawings.

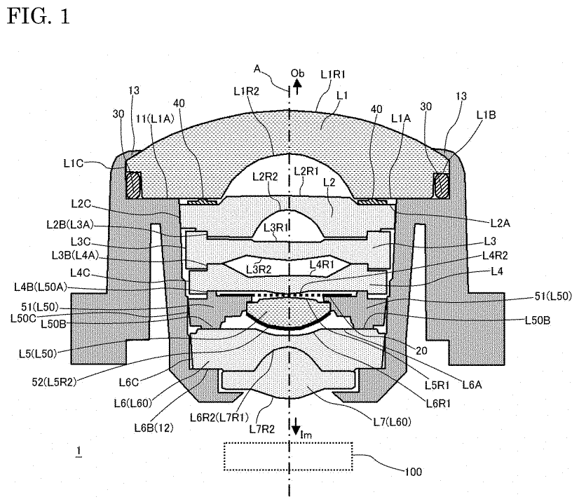

FIG. 1 is a cross-sectional view along an optical axis A of a lens unit 1 according to the present embodiment. Herein, an object (Ob) side is the upper side in the drawing, an image (Im) side is the lower side in the drawing, and an image pickup element 100 is positioned in the lowest part of the drawing. Each of lenses L1 to L7 is directly or indirectly fixed to a lens barrel 10. In FIG. 1, the configuration for fixing each lens and an aperture 20, or between each lens and the lens barrel 10 is mainly described, and the configuration for actually fixing the positional relationship of the image pickup element 100 and the lens barrel 10 is also provided, but the description thereof is omitted.

The image pickup element 100 is a 2-dimensional CMOS image sensor, each pixel is arranged two-dimensionally in a surface perpendicular to the optical axis A, and the image pickup element 100 is actually covered with a cover glass (not shown in the drawing). In FIG. 1, the lens unit 1 comprising the first lens L1 to the seventh lens L7 is configured. The lens unit 1 is configured so as to image a visible light image which is the target for imaging on the image pickup element 100 (image surface) with a desired field of view and a desired form.

In FIG. 1, the first lens L1 provided furthest on the object side (upper side in the drawing) is a fish-eyed lens, and mainly determines the field of view and the like of the image pickup apparatus. A second lens L2, a third lens L3, a fourth lens L4, a fifth lens L5, a sixth lens L6 and the seventh lens L7 are sequentially arranged on the image pickup element 100 side (image side). Each lens has a substantially symmetrical shape around the optical axis A. Further, an aperture 20 for controlling the light flux is provided between the fourth lens L4 and the fifth lens L5. Further, a light shielding plate to remove unnecessary light can be appropriately provided between the second lens L2 and the third lens L3, but a description thereof has been omitted in FIG. 1.

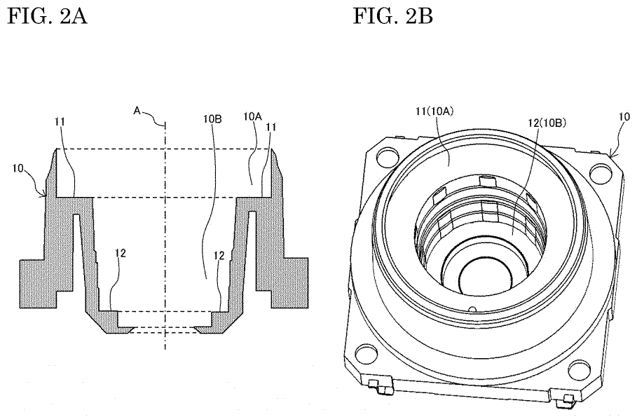

Further, FIG. 2A is a cross-sectional view along the optical axis A of only the lens barrel 10, and FIG. 2B is a perspective view of the lens barrel 10 viewed from the oblique upper side (object side) in FIG. 1. A first accommodation part 10A in which the inner peripheral surface is a hollow part having a substantially cylindrical shape is provided on the object side (upper side in the drawing) of the lens barrel 10, and the bottom surface of the image side of the first accommodation part 10A is a first placement part 11 abutting against the first lens L1. Further, the image side (lower side in the drawing) is more coaxial to the first accommodation part 10A than the first placement part 11, a second accommodation part 10B which is a hollow part having a substantially cylindrical shape with a smaller diameter than the first accommodation part 10A is provided, and the bottom surface of the image side of the second accommodation part 10B is a second placement part 12 abutting against a cemented lens L60 (the image side lens which is described later). The center axis of the first accommodation part 10A and the second accommodation part 10B are common, and are equivalent to the optical axis A. Further, as illustrated in FIG. 2A, the inner peripheral surface of the second accommodation part 10B actually becomes gradually smaller from the object side toward the image side.

In FIG. 1, the lens surfaces (surfaces through which the light forming the image passes) on the object side and the image side of each lens are appropriately subjected to curved surface (convex surface and concave surface) processing so as to provide the lens unit 1 with the desired imaging characteristics. Below, the lens surface of the object side in each lens is referred to as the first surface R1, and the lens surface of the image side is referred to as the second surface R2. Further, as the shape (convex surface or concave surface) of the lens surface, the shape of the first surface R1 means the shape viewed from the object side, and the shape of the second surface R2 means the shape viewed from the image side.

Generally, there are two types of material that serve as the material for constructing the lens in this kind of small image pickup apparatus: glass and resin material. In case of glass, the mechanical strength is high, but glass is expensive, and in the latter case of a resin material, the mechanical strength is low, but the resin material is inexpensive. Further, the coefficient of thermal expansion of glass is smaller than that of a resin material, thus, the lens in which the influence on the imaging characteristics (change in the focal point and the like) becomes large due to minute changes in the shape and position caused by the thermal expansion at high temperatures is preferably made of glass. Therefore, in order to make a high performance and inexpensive lens unit 1, lenses (glass lenses) made of glass are the only lenses which are preferable, and other lenses are preferably lenses (plastic lenses) made of a resin material.

From this point of view, in the embodiment, the first lens L1 arranged furthest on the object side is located on the outermost surface of the lens unit 1, and is therefore, a glass lens which does not easily become scratched. Further, since the lenses (fourth lens L4 and fifth lens L5) adjacent to the aperture 20 show significant changes in the focal length due to temperature changes, either lens (in the present embodiment, the fifth lens L5) is a glass lens. Inexpensive plastic lenses can be used as the other lenses.

The first lens L1 is a negative lens in which a lens surface L1R1 of the object side is a convex surface and a lens surface L1R2 of the image side is a concave surface. The lens surface L1R1 occupies almost the entirety of the upper surface side of the first lens L1. On the lower surface side (image side) of the first lens L1, a first lens first lower surface L1A constituted by a flat surface perpendicular to the optical axis A is provided on the outside of the lens surface L2R2. A first lens second lower surface L1B parallel to the first lens first lower surface L1A and located on the object side (upper side in the drawing) relative to the first lower surface L1A can be provided further outside of the first lens first lower surface L1A. Further, the outermost peripheral part of the first lens L1 forms a cylindrical shaped first lens outer peripheral surface L1C having the optical axis A as the center axis. Among these surfaces, the lens surfaces L1R1 and L1R2 are used optically, and the other surface can be used to fix the first lens L1 to the lens barrel 10.

In FIG. 1, the upper end side of the lens barrel 10 constitutes a first lens locking part 13 which is curved toward the optical axis A (center) side so as to suppress the movement to the object side of the first lens L1. Further, the first lens first lower surface L1A abuts against the first placement part 11 of the lens barrel 10. Therefore, the positional relationship in the optical axis A direction relative to the lens barrel 10 of the first lens L1 is determined by the first lens locking part 13 on the object side (upper surface in the drawing), and is determined by the first placement part 11 on the image side (upper surface in the drawing). In this case, a waterproof function on the inside of the lens barrel 10 can be obtained by arranging a ring shaped O-ring 30 that is compressed and elastically deformed in the direction perpendicular to the optical axis A direction in a gap between the first lens second lower surface L1B and the first placement part 11 further outside relative to the first lens first lower surface L1A. Note that, the shape of the aforementioned first lens locking part 13 is the shape after processing (heat swaging) in order to fix the first lens L1 to the lens barrel 10, and the shape of the upper end side of the lens barrel 10 prior to fixing is such that the first lens L1 can be inserted into the lens barrel 10 as illustrated in FIG. 1 from the upper side as illustrated in FIG. 2A.

Further, the first lens outer peripheral surface L1C abuts against the inner peripheral surface of the first accommodation part 10A in the lens barrel 10. The positional relationship between the first lens L1 and the lens barrel 10 in the direction perpendicular to the optical axis A is determined thereby. That is, the first lens L1 is fixed to the lens barrel 10 by the aforementioned configuration.

The second lens L2 is a negative lens in which a lens surface L2R1 of the object side is a convex surface and a lens surface L2R2 of the image side is a concave surface. A second lens first upper surface L2A which is perpendicular to the optical axis A and which is a flat surface positioned on the image side (lower side in the drawing) relative to the lens surface L2R1 is provided on the outside of the lens surface L2R1 on the object side (upper side in the drawing) of the second lens L2. Further, a stepped part (engagement structure) L2B constituted by a surface parallel to and a surface perpendicular to the optical axis A is provided outside relative to the lens surface L2R2 on the image side (lower side in the drawing) of the second lens L2. A second lens outer peripheral surface L2C which is the surface constituting the outermost periphery of the second lens L2 abuts against the inner peripheral surface of the second accommodation part 10B. The second lens outer peripheral surface L2C is formed into a substantially conical surface shape so that the inner diameter around the optical axis A gradually decreases toward the image side. The positional relationship between the second lens L2 and the direction perpendicular to the optical axis A of the lens barrel 10 is determined thereby.

Further, an elastic member 40 constituted by an elastic body between the second lens first upper surface L2A and the first lens second lower surface L1B and thin in the optical axis A direction is arranged in the region inside (side near the optical axis A) relative to the first placement part 11 and outside relative to the lens surface L1R2 and the lens surface L2R1. That is, the first lens L1 and the second lens L2 are not in direct contact in the direction along the optical axis A, and the elastic member 40 is provided therebetween.

The third lens L3 is a positive lens in which a lens surface L3R1 of the object side is a concave surface and a lens surface L3R2 of the image side is a convex surface. A stepped part (engagement structure) L3A formed on the object side (upper surface in the drawing) of the third lens L3 so as to engage with the stepped part L2B in the second lens L2 is provided on the outside of the lens surface L3R1. Further, a stepped part (engagement structure) L3B constituted by a surface parallel to and a surface perpendicular to the optical axis A is provided outside relative to the lens surface L3R2 on the image side (lower surface in the drawing) of the third lens L3. Further, a third lens outer peripheral surface L3C which is a surface having a substantially cylindrical shape constituting the outermost periphery of the third lens L3 is not in contact with the inner peripheral surface of the second accommodation part 10B.

The fourth lens L4 is a positive lens in which a surface L4R1 of the object side is a concave surface and a surface L4R2 of the image side is a convex surface. A stepped part (engagement structure) L4A formed on the object side (upper surface in the drawing) of the fourth lens L4 so as to engage with a stepped part L3B in the third lens L3 is provided on the outside of the lens surface L4R1. Further, a stepped part (engagement structure) L4B constituted by a surface parallel to and a surface perpendicular to the optical axis A is provided outside relative to the lens surface L4R2 on the image side (lower surface in the drawing) of the fourth lens L4. Further, a fourth lens outer peripheral surface L4C which is a surface having a substantially cylindrical shape constituting the outermost periphery of the fourth lens L4 is not in contact with the inner peripheral surface of the second accommodation part 10B. That is, the third lens L3 and the fourth lens L4 are not in contact with the lens barrel 10.

As stated above, the fifth lens L5 is made of glass, and is a positive lens in which the surface L5R1 of the object side is a convex surface and the surface L5R2 of the image side is a convex surface. However, unlike the other lenses, the fifth lens L5 is accommodated in the lens barrel 10 in a state in which the fifth lens L5 is press-fit and integrated in a lens holder 51 made of a resin material to provide a fifth lens body L50. That is, the fifth lens L5 is treated as a lens in the same manner as the third lens L3 and the fourth lens L4, which are made of a resin material, in the form of the fifth lens body L50 which includes the fifth lens L5.

A stepped part (engagement structure) L50A formed on the object side (upper surface in the drawing) of the fifth lens body L50 so as to engage with a stepped part L4B in the fourth lens L4 is provided on the lens holder 51 on the outside of the fifth lens L5. Further, a protrusion part L50B which protrudes locally from the periphery toward the image side (lower surface in the drawing) is provided outside relative to the fifth lens L5 on the image side (lower side in the drawing) of the fifth lens body L50. The details of the protrusion part L50B will be described later. Further, a fifth lens body outer peripheral surface L50C which is a surface constituting the outermost periphery of the fifth lens body L50 abuts against the inner peripheral surface of the second accommodation part 10B. The fifth lens body outer peripheral surface L50C is formed to a substantially conical surface shape such that the inner diameter around the optical axis A gradually decreases toward the image side. The positional relationship in the direction perpendicular to the optical axis A between the fifth lens body L50 (fifth lens L5) and the lens barrel 10 is determined thereby.

Further, an IR cut coating layer (infrared cut filter) 52 is formed on the lens surface L5R2 of the image side of the fifth lens L5. Due to the IR cut coating layer 52, near-infrared light which is a component other than visible light toward the image pickup element 100 side can be removed. When the imaging characteristics of the lens unit 1 are optimized for visible light, since the characteristics are not optimal for the near-infrared light, it is preferable that the near-infrared light does not reach the image pickup element 100 in order to obtain a good image. The IR cut coating layer 52 prevents the near-infrared light from traveling toward the image pickup element 100 side, so that only visible light images in which good imaging characteristics can be obtained are obtainable by the image pickup element 100. The IR cut coating layer 52 is formed, for example, by vapor deposition, to a thin film as a multilayer film which transmits light having a wavelength shorter than the cut-off wavelength and does not transmit light of a longer wavelength. This kind of IR cut coating layer 52, specifically, can be adequately formed on a glass lens, and thus, can be easily formed on the lens surface L5R2.

The sixth lens L6 is a negative lens in which a surface L6R1 of the object side is a concave surface and a surface L6R2 of the image side is a concave surface. The seventh lens L7 has a smaller outer diameter than the sixth lens L6, and is a positive lens in which a surface L7R1 of the object side is a convex surface and a surface L7R2 of the image side is a convex surface. Further, the sixth lens L6 and the seventh lens L7 are set so as to form a cemented lens (image side lens) L60 on the outermost image side by fitting and joining with the opposite lens surface. In short, the image side lens which is the lens that is the closest to the image side is substantially the cemented lens L60 in which the lens surface L6R2 of the image side of the sixth lens L6 is fitted and joined with the lens surface L7R1 of the object side of the seventh lens L7.

The cemented lens upper surface L6A which is a flat surface which abuts against the protrusion part L50B in the fifth lens body L50 on the outside of a lens surface L6R1 is provided on the object side (upper surface in the drawing) of the cemented lens L60 (sixth lens L6). Note that, FIG. 1 describes, for the sake of convenience, that the protrusion part L50B abuts against the cemented lens upper surface L6A on both sides which sandwich the optical axis A, and herein, the position of the protrusion part L50B as described later is not precisely reflected. The actual configuration and the precise position of the protrusion part L50B will be described later.

Further, the cemented lens lower surface L6B which is a flat surface perpendicular to the optical axis A is provided outside relative to the lens surface L7R2 on the image side (lower side in the drawing) of the cemented lens L60 (sixth lens L6). The cemented lens lower surface L6B abuts against the second placement part 12. The sixth lens outer peripheral surface L6C which is the surface constituting the outermost periphery of the cemented lens L60 (sixth lens L6) abuts against the inner peripheral surface of the second accommodation part 10B. The sixth lens outer peripheral surface L6C is formed in a substantially conical surface shape so that that inner diameter around the optical axis A gradually decreases toward the image side. Therefore, the position in the direction along the optical axis A of the cemented lens L60 is controlled by the lens barrel 10 (second placement part 12) on the image side.

In this case, the fifth lens body L50 (protrusion part L50B) is locked by the cemented lens L60 on the image side, thus, the position in the direction along the optical axis A of the fifth lens body L50 is controlled by the second placement part 12 (lens barrel 10) via the cemented lens L60 on the image side.

Further, according to the configuration, the position in the direction along the optical axis A of the fourth lens L4 is controlled by the lens barrel 10 via the fifth lens body L50 and the cemented lens L60 on the image side as a result of the engagement of the stepped part L4B and the stepped part L50A with each other. On the one hand, the position in the direction perpendicular to the optical axis A of the fourth lens L4 is determined by the inner peripheral surface of the second accommodation part 10B via the fifth lens body L50 by the stepped part L4B engaging with the stepped part L50A. Similarly, the position in the direction along the optical axis A of the third lens L3 is controlled by the lens barrel 10 via the fourth lens L4, the fifth lens body L50 and the cemented lens L60 on the image side by engaging the stepped part L3B with the stepped part L4A. On the one hand, the position in the direction perpendicular to the optical axis A of the third lens L3 is determined by the inner peripheral surface of the second accommodation part 10B via the fourth lens L4 and the fifth lens body L50 by the stepped part L3B engaging with the stepped part L4A.

Further, according to the configuration, the position in the direction along the optical axis A of the second lens L2 is controlled by the lens barrel 10 via the third lens L3, the fourth lens L4, the fifth lens body L50 and the cemented lens L60 on the image side by engaging the stepped part L2B with the stepped part L3A. On the one hand, the position in the direction perpendicular to the optical axis A of the second lens L2 is, as stated above, determined by the inner peripheral surface of the second accommodation part 10B.

That is, in the aforementioned configuration, among the second lens L2 to the cemented lens L60 (seventh lens L7), the second lens L2, the fifth lens L5 (fifth lens body L50) and the cemented lens L60 are the contact lenses of which the outer peripheral parts abut against the inner peripheral surface of the second accommodation part 10B in the lens barrel 10. These contact lenses have a fixed positional relationship between the lens barrel 10 in the direction perpendicular to the optical axis A thereby. On the one hand, the third lens L3, the fourth lens L4 are non-contact lenses which are not in direct contact with the inner peripheral surface of the second accommodation part 10B. The non-contact lens are fixed in a positional relationship between the lens barrel 10 in the orthogonal direction by fixing the positional relationship in the direction perpendicular to the optical axis A between the contacts lenses by directly or indirectly engaging with the contact lenses on the object side and the image side via the aforementioned stepped part (engagement structure). All of the second lens L2 to the cemented lens L60 (seventh lens L7) are in a positional relationship fixed between the lens barrel 10 in the direction perpendicular to the optical axis A thereby.

On the one hand, the outer peripheral surfaces of the third lens L3 and the fourth lens L4 are not in contact with the inner peripheral surface of the second accommodation part 10B. Therefore, a force caused by the thermal expansion difference between the third lens L3, the fourth lens L4 and the lens barrel 10 and applied to the third lens L3, the fourth lens L4 (lens system) and the lens barrel 10 is suppressed. Therefore, the distortion, etc., of the lens caused by the thermal expansion difference is suppressed, and the adverse effects of temperature changes on the imaging characteristics are reduced.

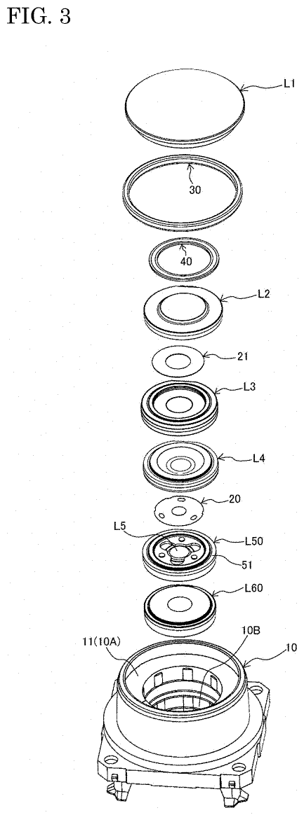

FIG. 3 is an exploded perspective view of the lens unit 1, and herein, also describes a light shielding plate 21 of which the description in FIG. 1 omitted. Herein, the cemented lens L60, the fifth lens body L50, the aperture 20, the fourth lens L4, the third lens L3, the light shielding plate 21, the second lens L2, the elastic member 40, the O-ring 30 and the first lens L1 are installed in order to the lens barrel 10 from the upper side (object side) in the drawing. As illustrated in the drawings, the elastic member 40 and the O-ring 30 are annular.

A crystalline plastic (polyethylene, polyamide, polytetrafluoroethylene) excellent in weatherability is preferably used as the material of the lens barrel 10. On the one hand, the second lens L2, the third lens L3, the fourth lens L4, the sixth lens L6 and the seventh lens L7 are constituted by an amorphous plastic (polycarbonate and the like) excellent in performance (light transmission and moldability) as the lens. Further, the lens holder 51 is constituted with the same amorphous plastic as the fourth lens L4, thus, the fifth lens body L50 can, as a whole, be handled as a plastic lens in the same manner as the fourth lens L4. As stated above, the first lens L1 and the fifth lens L5 are made of glass.

In the lens unit 1, the interval between the fifth lens L5 adjacent to the aperture 20 on the image side and the cemented lens (image side lens) L60 adjacent to fifth lens L5 on the image side has a large effect on the imaging characteristics, thus, it is necessary that this interval is precisely determined. Further, in the fifth lens L5, the infrared cut coating layer 52 is formed in L5R2 which is the lens surface of the cemented lens L60 side. In this case, if this interval is not optimized, flaring and ghosting may occur.

On the one hand, errors in the thickness along the optical axis A direction such as in the fourth lens L4 which is a plastic lens are, for example, in a range of several μm or less, whereas the errors in the thickness of the fifth lens L5 which is a glass lens manufactured by the polishing process is roughly larger in the range of several tens of μm which is coarser than that of the plastic lens. This lens unit 1 is constituted so as to be able to compensate for the influence of variations in the thickness of this kind of fifth lens L5 with respect to the interval between the fifth lens L5 and the cemented lens L60. This point is described below.

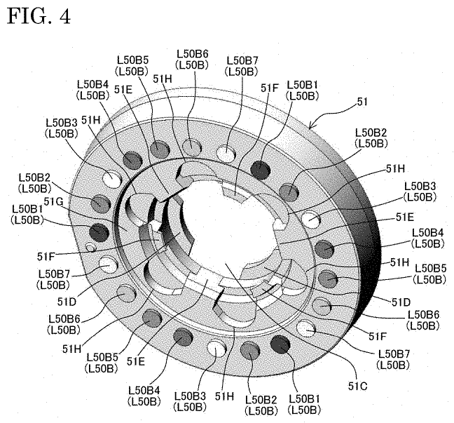

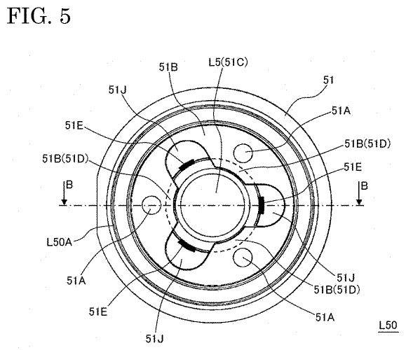

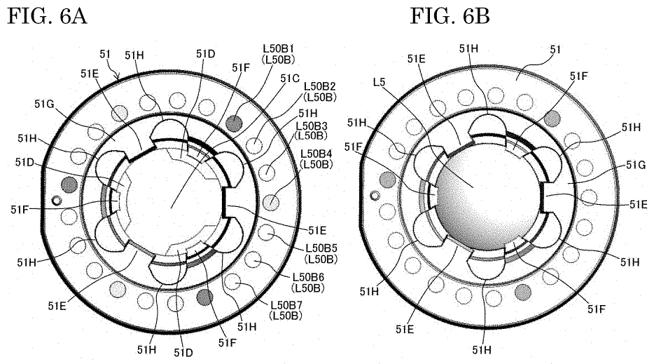

FIG. 4 is a perspective view of the lens holder 51 constituting the fifth lens body L50 viewed from the image side. FIG. 5 is a plan view of the lens holder 51 (fifth lens body L50) in which a fifth lens L5 has been arranged. FIGS. 6A and 6B are each a plan view of the lens holder 51 as viewed from the image side (FIG. 6A illustrating the lens holder 51 alone; FIG. 6B illustrating the lens holder 51 with the fifth lens L5 arranged therein). Note that, the above description is mainly based on the assembled structure in FIG. 1, whereas in the following, each constituent element is described prior (before assembly) to the state in FIG. 1. In this case, the optical axis A, the object side, the image side and the like mean the state when each constituent element is arranged in FIG. 1.

As illustrated in FIG. 4, the protrusion part L50B is formed into 21 equal intervals in the circumferential direction, and each interval is divided into a group (protrusion part group) consisting of L50B1 to a group consisting of L50B7 constituted by three protrusion parts L50B in accordance with the protrusion amount to the image side. This protrusion amount is set so as to increase from L50B1 to L50B7. Therefore, when manufacturing this lens unit 1, the protrusion part L50B actually abutting against the cemented lens upper surface L6A can be selected from among the aforementioned L50B1 to L50B7 in accordance with the measured thickness of the fifth lens L5 after being joined to the aforementioned lens holder 51 so that the interval between the fifth lens L5 and the cemented lens L60 is an appropriate value. In this case, the protrusion part L50B of the protrusion part group having a larger protrusion amount than the selected protrusion part group can be made to have a smaller protrusion amount than the selected protrusion part group by mechanical or heating and melting processing.

The point that processing is performed on the protrusion part L50B is the same as the technique described in Japanese Unexamined Patent Application Publication No. 2018-54922. However, in the technique described in Japanese Unexamined Patent Application Publication No. 2018-54922, since the accuracy of the protrusion amount after the processing reflects the accuracy of the lens interval, a high processing accuracy is necessary. With respect thereto, since the processing used in the case of this lens unit 1 is performed only to make the protrusion amount lower than the selected protrusion part group, a high processing accuracy is not necessary. On the one hand, the lens interval is determined only by the protrusion amount of the protrusion part L50B of the selected protrusion part group independent of this process and is determined by the accuracy of the manufacturing (molding) of the lens holder 51, thus, the accuracy is higher than the processing accuracy.

Further, if the three protrusion parts L50B1 to L50B7 are provided as illustrated in the drawing, since the fifth lens body 50 (lens holder 51) can be supported at three points on the cemented lens L60, the interval between the fifth lens L5 and the cemented lens L60 can be determined with a high accuracy after compensating for the variation in the thickness of the aforementioned fifth lens L5. The same is true not only for the variation in the thickness of the fifth lens L5, but also for the variation during the manufacturing of the cemented lens L60 and the lens barrel 10. Therefore, a high accuracy processing is not necessary, and it is possible to make fine adjustments to the lens interval.

Further, since the fifth lens body L50 is supported on the image side by the cemented lens L60 (cemented lens upper surface L6A) in the protrusion part L50B, the force is specifically applied to the cemented lens L60 at the three protrusion parts L50B during the installation (press-fitting) of the fifth lens body L50. If this force is not uniform, the force acting to cause deformation (distortion) to the lens barrel 10 may act on the lens barrel 10 via the cemented lens L60. Due to the aforementioned configuration, since the three protrusion parts L50B belonging to each protrusion part group are arranged at equal intervals (phase: 120°) in the circumferential direction symmetric around the optical axis A as illustrated in FIG. 4, the force acting to deform the lens barrel 10 is suppressed in this way.

Next, the relationship between the lens holder 51 and the fifth lens L5 will be described. As illustrated in FIG. 4, a lens installation hole 51C which is a hole part for accommodating the fifth lens L5 from the image side is formed in the lens holder 51, and the fifth lens L5 is locked on the object side by a lens fixing surface 51D which becomes the bottom surface on the object side of the lens installation hole 51C. That is, the fifth lens L5 is locked by the lens fixing surface 51D on the object side and fixed to the lens holder 51 in the optical axis A direction. As illustrated in FIG. 6A, the lens fixing surface 51D is formed along the outer peripheral part of the fifth lens L5, but is divided into three parts in the circumferential direction.

Further, in the lens installation hole 51C, the outer peripheral part of the fifth lens L5 abuts against ribs 51E protruding locally to the optical axis A side as illustrated in FIG. 4. The ribs 51E are formed at three positions at equal intervals in the circumferential direction where the lens fixing surface 51D is not provided. That is, in the direction perpendicular to the optical axis A, the fifth lens L5 is fixed to the lens holder 51 with the periphery locked by the three ribs 51E.

Further, in FIG. 4, three small claw-shaped projection parts 51F curved to the optical axis A side in the same manner as the first lens locking part 13 are provided in the circumferential direction. As stated above, the shape of a projection part 51F changes during the manufacturing process, and herein, the state in which the fifth lens body L50 has been formed is illustrated.

Further, as illustrated in FIGS. 6A and 6B, a first adhesive agent groove 51H which is a portion (groove) dug down to a lens holder bottom surface 51G as the bottom surface perpendicular to the optical axis A is formed outside of the lens installation hole 51C in a portion on the image side of the lens holder 51 where the ribs 51E and the projection part 51F are not formed in the circumferential direction. Six first adhesive agent grooves 51H are formed at equal intervals in the circumferential direction so as to connect with the lens installation hole 51C. Further, as illustrated in FIG. 5, a second adhesive agent groove (recessed part) 51J which is the portion (groove) dug down to an aperture placement surface 51B as the bottom surface perpendicular to the optical axis A is formed outside of the lens installation hole 51C on the object side of the lens holder 51. The aperture placement surface 51B will be described later. Three second adhesive agent grooves 51J are formed at equal intervals in the circumferential direction in a portion where the ribs 51E are formed in the circumferential direction so as to connect with the lens installation hole 51C.

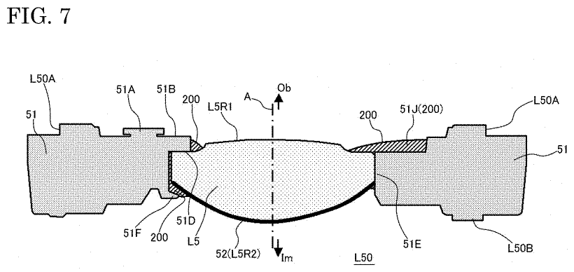

FIG. 7 is a cross-sectional view along the optical axis A in the B-B direction of FIG. 5 in the fifth lens body L50. In FIG. 7, the left side on the optical axis A illustrates a cross-section of the portion which has the lens fixing surface 51D, and is without the ribs 51E and the second adhesive agent groove 51J. The right side of the optical axis A illustrates a cross-section of the portion which does not have the lens fixing surface 51D, and has the ribs 51E and the second adhesive agent groove 51J. The fifth lens L5 and the lens holder 51 are fixed to each other by the adhesive agent between them. Unlike FIG. 5, FIG. 7 also illustrates the adhesive agent layer 200 after fixing.

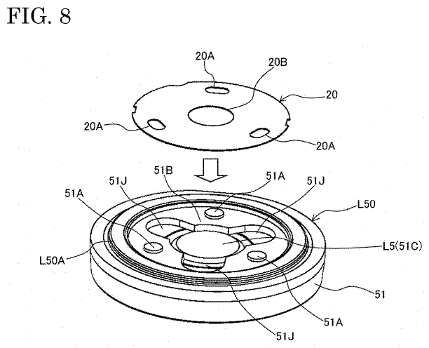

On the one hand, FIG. 8 is a perspective view viewed from the object side of the aperture 20 and the fifth lens body L50. As illustrated in FIG. 8, three projections 51A having a circular cross-sectional shape perpendicular to the optical axis A are formed at equal intervals in the circumferential direction on the object side of the lens holder 51. Further, the periphery of the projections 51A is a flat surface (aperture placement surface 51B) perpendicular to the optical axis A. On the one hand, three positioning holes 20A penetrating the thin flat aperture 20 in the optical axis A direction are formed so as to correspond with the projections 51A outside a center opening 20B. Therefore, the positioning holes 20A can engage with the projections 51A, and the aperture 20 can be fixed in a state placed on the aperture placement surface 51B. In this case, the aperture 20 can be fixed to the lens holder 51 (fifth lens body L50) by, for example, melting the projections 51A protruding from the positioning holes 20A to the object side after the placement of the aperture 20 and welding to the periphery.

In FIG. 1, the aperture 20 is provided perpendicular to the optical axis A, and if this angle fluctuates, ghosting may occur in the image pickup apparatus. With respect thereto, the aperture 20 is fixed in an appropriate manner to the fifth lens body L50, and the fluctuation of the angle relative to the optical axis A of the aperture 20 is suppressed by such a configuration.

In this case, as illustrated in FIG. 8, the positioning hole 20A is formed longer in the circumferential direction around the optical axis A than in the radial direction of the optical axis A. As a result, with the aperture 20 in a mounted state, since the aperture 20 can be rotated around the optical axis A by a small amount, the installation on the fifth lens body L50 of the aperture 20 is particularly easy. On the one hand, if the opening 20B of the aperture 20 is considered to be a circle centered on the optical axis A, since the condition of the opening 20B does not change during the aforementioned rotation, the imaging characteristics are not adversely affected even if the aperture 20 rotates in this manner. Therefore, by this configuration, the aperture 20 can be fixed to the lens holder 51 in a highly accurate positional relationship with good reproducibility. In the aforementioned example, the projections 51A have a circular shape, but can include the case when the shape is not circular, and more generally, the length of the positioning hole 20A along the circumferential direction around the optical axis A may be set longer than the length of the projections 51A along the same direction. Therefore, the operation to install the aperture in the lens holder becomes easy, and does not cause an adverse effect to the imaging characteristics.

As illustrated in FIGS. 5 and 7, the lens fixing surface 51D which supports the fifth lens L5 and the aperture placement surface 51B which is fixed to the aperture 20 are formed so as to overlap when viewed in the optical axis A direction. As a result, by constituting so that the region abutting against the fifth lens L5 on the lens fixing surface 51D overlaps with the region abutting against the aperture 20 on the aperture placement surface 51B when viewed in the optical axis A direction, the positional relationship of the lens holder 51, the fifth lens L5, and the aperture 20 in the optical axis A direction can be precisely determined.

A method (method for manufacturing of the lens unit) for forming the fifth lens body L50 in this manner, and then installing the fifth lens body L50 on the lens barrel 10 will be described below.

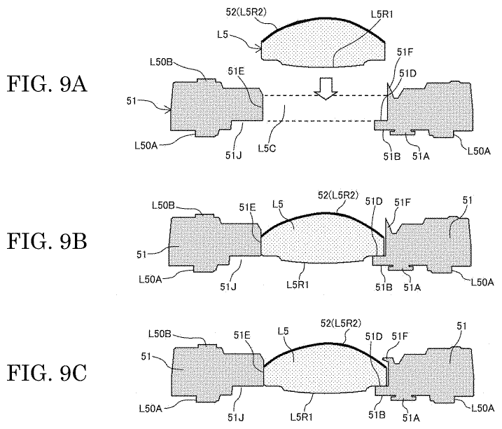

FIGS. 9A through 9C illustrate a process for manufacturing the fifth lens body L50 and are each a cross-sectional view corresponding to FIG. 7. In the actual manufacturing, since the fifth lens body L50 is considered to be in a state which is vertically inverted compared to the state illustrated in FIGS. 1 and 7, herein, the configuration in FIG. 7 is illustrated rotated 180°. First, FIG. 9A illustrates the situation prior to press-fitting the fifth lens L5 in the lens holder 51. Herein, the projection part 51F is not a shape which is curved toward the optical axis A side as illustrated in FIGS. 4 and 7, but is a shape protruding toward the image side. Therefore, the projection part 51F does not become an obstacle when the fifth lens L5 is accommodated in the lens installation hole 51C from the image side (upper surface in the drawing). Further, the aforementioned IR cut coating layer (infrared cut filter) 52 is formed in the lens surface L5R2 of the fifth lens L5.

Next, as illustrated in FIG. 9B, the fifth lens L5 is press-fit into the lens installation hole 51C from the image side (lens arranging process). In this case, as stated above, the position of the fifth lens L5 in the optical axis A direction is determined by the lens fixing surface MD, and the position in the direction perpendicular to the optical axis A is determined by the ribs ME.

In this case, the ribs ME are formed so that the outer peripheral surface of the fifth lens L5 abuts the three ribs ME. Since the lens holder 51 is made of a resin material, there is the risk that, in this case, a small chip is specifically discharged toward the object side. As stated above, when the second adhesive agent groove (recessed part) 51J is provided so as to overlap the ribs ME, the second adhesive agent groove (recessed part) 51J can be provided in place of the lens fixing surface MD locking the fifth lens L5 on the object side in the position where the ribs ME are present. Therefore, the chip is prevented from being disposed between the lens fixing surface 51D and the fifth lens L5, and the chip falls from the lens holder 51, or is accommodated in the second adhesive agent groove 51J. Therefore, this reduces the influence of the chip on the positional relationship with the lens holder 51 of the fifth lens L5, and subsequently, the positional relationship between the fourth lens L4 and the lens holder 51.

Next, as illustrated in FIG. 9C, a process (swaging process) is performed (swaging step) so that the projection part 51F is bent toward the optical axis A side (inside). However, in this case, the projection part 51F is not in contact with the fifth lens L5. Therefore, the positional relationship between the fifth lens L5 and the lens holder 51 is not influenced by this swaging process.

In this state, the fifth lens L5 is fixed in the lens installation hole 51C by the adhesive agent (fixing process). In this case, by providing the adhesive agent prior to solidification in the first adhesive agent groove 51H and the second adhesive agent groove 51J in FIGS. 4 to 6, the adhesive agent is filled specifically in the gap between the outer peripheral part of the fifth lens L5 on the left side in FIG. 9C and the inner surface of the lens installation hole 51C. Then, by solidifying the adhesive agent, a solidified adhesive agent layer 200 is formed as illustrated in FIG. 7, and the fifth lens L5 is fixed to the lens holder 51. In this case, by processing the projection part 51F as stated above, the fifth lens L5 can be prevented from moving prior to the solidification of the adhesive agent. Furthermore, as illustrated in FIG. 7, since the adhesive agent also accumulates in the gap between the projection part 51F and the fifth lens L5 prior to solidification, the fifth lens L5 is fixed to the lens holder 51 even in this portion, and the fifth lens L5 can be joined more firmly to the lens holder 51.

When performing the aforementioned operation, if there are locations where excess solidified adhesive agent abuts against the cemented lens L60, the fourth lens L4 or the lens barrel 10 in the fifth lens body L50, the accuracy of the positioning of the fifth lens L5 itself and the fourth lens L4 deteriorates thereby. With respect thereto, by supplying the adhesive agent during the fixing process prior to solidification in the first adhesive agent groove 51H and the second adhesive agent groove 51J which are both locally dug down, the adhesive agent prior to solidification is prevented from existing in other locations. Further, the excess adhesive agent which leaked to the image side during the joining of the fifth lens L5 and the lens holder 51 is accommodated in the first adhesive agent groove 51H, and the excess adhesive agent which leaked to the object side is accommodated in the second adhesive agent groove 51J. As stated above, the fifth lens body L50 having the cross-sectional structure illustrated in FIG. 7 can be obtained.

Then, in the state illustrated in FIG. 7, the thickness of the fifth lens L5 in the optical axis A direction is measured. The measurement is performed by a method for measuring the shape of each type of contact or non-contact lens. Then, as stated above, it is recognized which protrusion part group among the protrusion part groups L50B1 to L50B7 is used so as to obtain the optimal lens interval in accordance with the measured thickness (selection process).

Then, all of the protrusion parts L50B belonging to the protrusion part group having a larger protrusion amount than the selected protrusion part group are subjected to a mechanical or heating and melting processing, and processing is performed so that the protrusion amount of these protrusion parts L50B becomes lower than the selected protrusion part group (protrusion part machine processing). As stated above, in this case, since it is sufficient if only the protrusion part L50B of the selected protrusion part groups can be abutted against the cemented lens upper surface L6A, and it is not necessary to precisely control the protrusion amount, a high processing accuracy is not necessary for this processing.

Further, as illustrated in FIG. 8, the aperture 20 is installed (aperture arranging process) in the object side of the fifth lens body L50 formed as stated above by engaging the projection 51A in the positioning hole 20A. Then, the projection 51A which protrudes from the positioning hole 20A to the object side is subjected to heating and melting processing to fix the aperture 20 to the fifth lens body L50 (lens holder 51).

Then, after the aforementioned processing of the protrusion part, the fifth lens body L50 is arranged (lens body arranging process) on the lens barrel 10 after the cemented lens L60 is arranged. Then, the constituent elements of the object side relative to the fourth lens L4 in FIG. 3 are installed on the lens barrel 10 in order. Therefore, the aforementioned lens unit 1 can be easily manufactured in a state in which the positional relationships between the fifth lens L5, the cemented lens L60, the fourth lens L4, the lens barrel 10 and the aperture 20 are precisely determined.

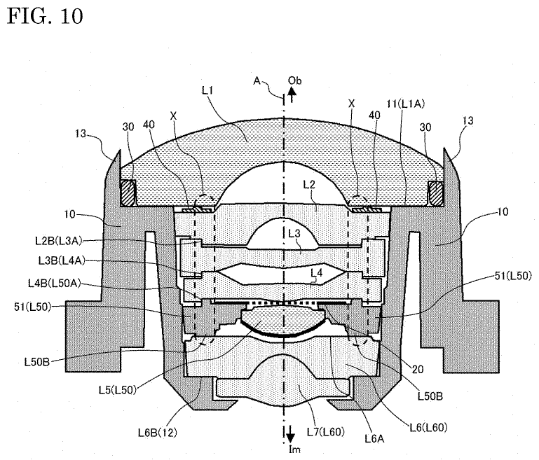

As stated above, the cemented lens L60, the fifth lens body L50, the fourth lens L4, the third lens L3 and the second lens L2 are press-fit into the lens barrel 10 (second accommodation part 10B). In this regard, FIG. 10 illustrates the configuration, corresponding to FIG. 1, when the lens barrel 10 has up to the first lens L1 in FIG. 3 set therein. Herein, specifically, the positional relationship of the protrusion part L50B and stepped parts L4B(L50A), L3B(L4A) and L2B(L3A) and the elastic member 40 positioned on the object side relative to the protrusion part L50B is emphasized in the drawing.

As stated above, since the fifth lens body L50 is locked with the protrusion part L50B by the cemented lens L60 which has already been arranged on the lens barrel 10, a force that deforms the lens barrel 10 may be applied to the lens barrel 10 side depending on the balance with the force applied to the cemented lens L60 side during the press-fitting of the fifth lens body L50. As stated above, the selected protrusion part L50B is symmetric around the optical axis A, thus, the aforementioned situation is suppressed. However, the force which acts on the lens barrel 10 side in this way is the same as when the constituent elements of the object side are installed relative to the fourth lens L4 in FIG. 3. Alternatively, as a result, the distortion may occur in each plastic lens (fourth lens L4 to second lens L2) on the side where each plastic lens is to be installed.

Herein, in the case when the constituent elements of the object side are installed relative to the fourth lens L4, specifically, in FIG. 10, a force is applied to the stepped parts L4B (L50A), L3B (L4A), and L2B (L3A) and the elastic member 40 from the image side. A region (load region X) illustrated by the dashed line in FIG. 10 illustrates the range to which the protrusion part L50B extends in the optical axis A direction. As illustrated herein, the aforementioned stepped parts L4B (L50A), L3B (L4A), L2B (L3A) and the elastic member 40 are either in the load region X, or overlap with the load region X. Therefore, when press-fitting the fourth lens L4, the third lens L3 and the second lens L2, or when press-fitting the first lens L1 via the elastic member 40, the force applied to the image side is transmitted directly below the protrusion part L50B, and the distortion occurring in the lens barrel 10 and each lens is suppressed by this force in the same manner as when the fifth lens body L50 is press-fitted. Therefore, the occurrence of distortion in the lens barrel 10 and the like is suppressed when manufacturing the lens unit 1. Therefore, the lens unit 1 having good imaging characteristics can be easily manufactured. In this case, if the stepped part L50A (L4B) is formed as a circumference as illustrated in FIG. 8, and the plurality of protrusion parts L50B are arranged on the circumference as illustrated in FIG. 4, the aforementioned positional relationship is maintained regardless of which protrusion part group is selected. The same is true for the stepped parts L3B (L4A) and L2B (L3A).

Note that, in the aforementioned example, the fifth lens L5 (image side adjacent lens) is a glass lens, the fifth lens L5 and the cemented lens L60 adjacent to the image side (one side) abut against the protrusion part L50B in the lens holder 51, and the fifth lens and the fourth lens L4 adjacent to L5 on the object side (other side) engage with the stepped part L4B (L50B). However, when a precise adjustment of the interval between the glass lens and the lens of the object side is necessary, the sides on which the protrusion part and the stepped part (engagement structure) are respectively provided in the lens holder may be reversed from the aforementioned example to carry out the same method for manufacturing. That is, the sides on which the protrusion part or the stepped part (engagement structure) in the lens holder which holds the glass lens is formed with are appropriately designed in accordance with the configuration of the lens system.

First, in the configuration of FIG. 1, the second lens L2, the fifth lens L5 (fifth lens body L50) and the cemented lens L60 are the contact lenses whose outer peripheral parts abut against the lens barrel 10, and the third lens L3 and the fourth lens L4 are designated as non-contact lenses which only contact the lens barrel 10 via other lenses. However, which among the plurality of lenses is designated as the contact lens and the non-contact lens is appropriately set, and in any case, the aforementioned configuration can determine the positional relationship between the lenses adjacent to the glass lens (lens holder).

### Primary Characteristics of the Present Embodiment

The brief summary of the characteristics of the present embodiment is as follows.

(1) A lens unit 1 comprises a first lens L1 arranged furthest on an object (Ob) side along an optical axis A, a plurality of lenses (second lens L2 to seventh lens L7) arranged on an image (Im) side relative to the first lens L1, and a lens barrel 10 which accommodates the first lens L1 and the plurality of lenses, wherein a glass lens (fifth lens L5) which is one lens among the plurality of lenses and is made of glass is supported by a lens holder 51 on the outside viewed from the optical axis A and is accommodated in the lens barrel 10. A plurality of protrusion parts L50B protruding locally toward one side are formed in the lens holder 51 on one side (image side) in the optical axis A direction divided into a plurality of protrusion part groups (L50B1 to L50B7) in accordance with the protrusion amount, and the positional relationship between the one side lens (cemented lens L60) which is a lens adjacent to the glass lens (fifth lens L5) on the one side in the optical axis A direction and the glass lens (fifth lens L5) in the optical axis A direction is determined by locking the one side lens by the plurality of protrusion parts L50B belonging to one of the protrusion part groups.

In this configuration, the fifth lens body L50 in which the fifth lens L5 is integrated with the lens holder 51 is accommodated in the lens barrel 10. The fifth lens body L50 (lens holder 51) and the cemented lens L60 abut against the plurality of protrusion parts L50B formed in the lens holder 51, and the interval in the optical axis A direction between the fifth lens L5 and the cemented lens L60 is determined by the protrusion amount of this protrusion part L50B. Herein, since the protrusion amount of the protrusion part L50B can be precisely determined during the formation of the lens holder 51 in each protrusion part group (L50B1 to L50B7), the interval can be finely adjusted by selecting the protrusion part group. Even when there is variation in the thickness, etc., of the fifth lens L5, this variation can be compensated for, and the imaging characteristics of the lens unit 1 can be improved.

(2) The positional relationship of an other side lens (fourth lens L4) which is the lens adjacent to the fifth lens L5 on the other side (object side) in a lens holder 51 and the lens holder 51 is fixed in at least one of the optical axis A direction and the direction perpendicular to the optical axis A by engaging engagement structures (L4B, L50A) formed together. Herein, when viewed from the optical axis A direction, the protrusion part L50B and the engagement structures (L4B, L50A) have overlapping regions.

In this configuration, on the object side of the fifth lens L5, the positional relationship between the fifth lens L5, the fourth lens L4 adjacent to the fifth lens L5, and the lens holder 51 is determined by the engagement structures (L4B, L50A). The positional relationship between the cemented lens L60, the fifth lens L5 (the fifth lens body L50), and the fourth lens L4 is determined. At this time, when viewed from the optical axis A direction, the engagement structure (L4B, L50A) and the protrusion part L50B are connected. By overlapping, when the fourth lens L4 is incorporated into the lens barrel 10 after the fifth lens body L50, the occurrence of distortion in the lens barrel 10 and the plastic lens (the fourth lens L4) is suppressed.

(3) A cemented lens L60 in which two adjacent lenses (sixth lens L6 and seventh lens L7) in the optical axis A direction are joined together constitutes the one side lens.

In this configuration, the one side lens is the cemented lens L60. Such a configuration increases the degrees of freedom of the configuration of a lens system.

(4) A thin-film infrared cut filter 52 which blocks light of a wavelength longer than the light which is the target for imaging is formed on a lens surface L5R2 on the image side in the fifth lens L5.

By using the thin-film infrared cut filter 52, specifically, near-infrared light that is not necessary as a target for imaging and does not yield good imaging characteristics is prevented from reaching the image surface (image pickup element 100), and it becomes unnecessary to provide the infrared cut filter as a separate component. While the interval between the fifth lens L5 on which the infrared cut filter 52 has been formed and the image side lens L60 may influence the occurrence of ghosting and flaring, such adverse effects are suppressed by finely adjusting the interval using the aforementioned protrusion part L50B.

(5) A method for manufacturing a lens unit 1 comprises, a lens arranging process which arranges a fifth lens L5 in a lens installation hole 51C which is a hole part dug down in the optical axis A direction in a region around an optical axis A in a lens holder 51, a fixing process in which an adhesive agent is fixed between the arranged fifth lens L5 and the inner surface of the lens installation hole 51C, a selection process which measures the thickness along the optical axis A direction of the fifth lens L5 after fixing and selects one protrusion part group in accordance with the thickness, a protrusion part machine process which processes a protrusion part L50B belonging to another protrusion part group having a larger protrusion amount than the selected protrusion part group so that the protrusion part L50B belonging to the selected protrusion part group can lock a cemented lens L60, and after the protrusion part machine process, a lens body arranging process which arranges, in the lens barrel 10, the lens holder 51 in which the fifth lens L5 is fixed.

In the method for manufacturing, the fifth lens body L50 is manufactured by the lens arranging process and the fixing process. Then, the fifth lens body L50 is arranged in the lens barrel 10 by the lens body arranging process after it was determined that the protrusion part (protrusion part group) which abuts against the cemented lens L60 has an appropriate interval between the cemented lens L60 and the fifth lens L5 by the selection process and the protrusion part machine processing. In the protrusion part machine processing, processing is performed to the protrusion part L50B having a larger protrusion amount than the selected protrusion part groups, but a high accuracy is not necessary for this processing. Therefore, the fine adjustment of the lens interval is possible, and the manufacturing of the lens unit 1 is easy.

(6) A projection part 51F protruding to the side opposite (image side) the side (object side) where the lens installation hole 51C is dug down is formed along the optical axis A direction in the periphery of the lens installation hole 51C in the lens holder 51 viewed from the optical axis A. A swaging step for bending the projection part 51F to the optical axis A side in a non-contact state with the fifth lens L5 is provided after the lens arranging process and prior to the fixing process.

By providing the projection part 51F in the lens holder 51 in this way, the operation for accommodating the fifth lens L5 within the lens installation hole 51C is easy, and the fifth lens L5 is fixed to the lens holder 51 after the fixing process, even in the location where there is a projection part 51F. Further, after the swaging step, the fifth lens L5 is prevented from moving from the lens holder 51 prior to solidification of the adhesive agent.

(7) An aperture arranging process which installs an aperture 20 on the surface (aperture placement surface 51B) of the other side (object side) of the lens holder 51 is provided after the fixing process and prior to the lens body arranging process.

By this method for manufacturing, not only the fifth lens L5, but also the aperture 20 is fixed to the lens holder 51. Therefore, the fifth lens L5, the cemented lens L60, the fourth lens L4, and the positional relationship between these and the aperture 20 are fixed by the lens holder 51.

Note that, other than the aforementioned example, it is possible to construct a lens system including the aforementioned glass lenses, and one side thereof, an image side, or specifically, an aperture. In this case, the number of other lenses in the lens system is arbitrary.

The present invention is explained based on the embodiment and modifications; however, it is understood by a person skilled in the art that, as the embodiment is presented as an example, various modifications may be made with respect to the combination of components, or the like, and those modifications are also within the scope of the present invention.

What is claimed is:

1. A lens unit comprising:
a first lens arranged furthest on an object side along an optical axis;
a plurality of lenses arranged on an image side relative to the first lens; and
a lens barrel accommodating the first lens and the plurality of lenses, wherein
the plurality of lenses include a glass lens that is made of glass, supported by a lens holder outside as viewed from the optical axis, and accommodated in the lens barrel,
the lens holder is provided, on one side in an optical axis direction, with a plurality of protrusion parts locally protruding toward the one side, the plurality of protrusion parts being divided into a plurality of protrusion part groups in accordance with a protrusion amount, and
the plurality of lenses include a one side lens that is adjacent to the glass lens on the one side in the optical axis direction and is locked by protrusion parts belonging to one of the plurality of protrusion part groups to allow a positional relationship between the one side lens and the glass lens to be determined in the optical axis direction.

2. The lens unit according to claim 1, wherein
the plurality of lenses include an other side lens that is adjacent to the glass lens on another side of the lens holder, with an engagement structure formed in the other side lens and an engagement structure formed in the lens holder engaging with each other to allow a positional relationship between the other side lens and the lens holder to be fixed in at least the optical axis direction or a direction perpendicular to the optical axis, and
the plurality of protrusion parts and the engagement structures formed in the other side lens and in the lens holder have overlapping regions when viewed in the optical axis direction.

3. The lens unit according to claim 1, wherein the plurality of lenses include two lenses that are adjacent to each other in the optical axis direction and are joined together to form a cemented lens serving as the one side lens.

4. The lens unit according to claim 1, wherein a thin-film infrared cut filter that blocks light of a longer wavelength than light as a target for imaging is formed on a surface on the image side of the glass lens.

5. The lens unit according to claim 2, wherein the plurality of lenses include two lenses that are adjacent to each other in the optical axis direction and are joined together to form a cemented lens serving as the one side lens.

6. The lens unit according to claim 5, wherein a thin-film infrared cut filter that blocks light of a longer wavelength than light as a target for imaging is formed on a surface on the image side of the glass lens.

7. A lens unit manufacturing method for manufacturing the lens unit according to claim 1, comprising:
arranging the glass lens in a lens installation hole made by digging a region around the optical axis of the lens holder down in the optical axis direction;
fixing the glass lens to an inner surface of the lens installation hole with an adhesive agent;
measuring a thickness along the optical axis direction of the glass lens after fixing, and selecting a protrusion part group from among the plurality of protrusion part groups in accordance with the thickness;
processing protrusion parts that belong to another protrusion part group and have a larger protrusion amount than protrusion parts belonging to the protrusion part group as selected, to allow the protrusion parts belonging to the protrusion part group as selected to lock the one side lens; and
arranging a lens body that includes the glass lens fixed to the lens holder in the lens barrel after the processing of protrusion parts.

8. The lens unit manufacturing method according to claim 7, wherein
a projection part, which protrudes to a side opposite to a side where the lens installation hole is dug down along the optical axis direction, is formed in a periphery of the lens installation hole in the lens holder as viewed from the optical axis, and
the lens unit manufacturing method includes, between the arranging and the fixing of the glass lens, swaging to bend the projection part toward the optical axis while keeping the projection part in a non-contact state with the glass lens.

9. The lens unit manufacturing method according to claim 7, which includes, between the fixing of the glass lens and the arranging of the lens body, installing an aperture on a surface on another side of the lens holder.
